(19) United States
(12) Patent Application Publication
(10) Pub. No.: US 2026/0250198 A1
(43) Pub. Date: Aug. 27, 2026

(54) HARDENING ACCELERATOR COMPOSITION FOR CEMENTITIOUS COMPOSITIONS, CEMENTITIOUS COMPOSITION AND PROCESS FOR ACCELERATING THE HARDENING OF A CEMENTITIOUS COMPOSITION

(71) Applicant: Construction Research & Technology GmbH, Trostberg (DE)

(72) Inventors: Ida Ros, Treviso (IT); Oliver Mazanec, Trostberg (DE); Pere Borralleras Mas, Barcelona (ES)

(21) Appl. No.: 18/874,882

(22) PCT Filed: Jun. 22, 2023
(86) PCT No.: PCT/EP2023/066960

§ 371 Date: Dec. 13, 2024

(30) Foreign Application Priority Data
Jun. 22, 2022 (EP) 22180389.3

(51) Int. Cl. C04B 22/00; C04B 14/06; C04B 24/12; C04B 28/04; C04B 40/00; C04B 103/14

(52) U.S. Cl. CPC C04B 22/00863; C04B 14/06; C04B 24/121; C04B 28/04; C04B 40/0039; C04B 2103/14

(57) ABSTRACT

A hardening accelerator composition for cementitious compositions comprises a C—S—H seed component comprising a finely dispersed mineral constituent stabilized by a polymeric water-soluble dispersant, the mineral constituent comprising a semi-ordered calcium silicate hydrate having an apparent crystallite size of 15 nm or less, and an alkanolamine selected from diethanolamine (DEA) and methyl diethanolamine (MDEA), or mixtures thereof. The hardening accelerator composition allows for a greater hardening acceleration and promotion of compressive strength development of cement than either agent alone. Said improvement in compressive strength is favorable in view of reducing the amount of cement or to improve production efficiency accompanied by reducing production time.

The present invention relates to a hardening accelerator composition for cementitious compositions, a cementitious composition and a process for accelerating the hardening of a cementitious composition.

The construction sector is one of the largest CO₂ producers as especially in the production of cement, huge amounts of CO₂ are released. Thus, reducing the amount of cement, e.g. by partial replacement with supplementary cementitious materials (SCMs), would be favorable. In cement hydration, the cement phases react with water to form mainly the hydrate phases calcium silicate hydrate, ettringite, calcium-aluminate-ferrite phases, monosulfate (kuzelite) and portlandite which are important for development of compressive strength. Therefore, the reduction of the amount of cement as described above usually negatively impacts the development of high compressive strength, especially at early ages and at low temperatures.

Compressive strength development may be improved by accelerating the cement hydration, e.g. by addition of a hardening accelerator composition such as calcium silicate hydrate to cement. Common accelerators are, for example, calcium nitrate or sodium thiocyanate. In cold environments and ages earlier than 12 h, such accelerators are not effective and the use of calcium silicate hydrate (C—S—H) may be necessary. Such C—S—H accelerators are known from the prior art: WO 2010/026155 describes a process for the preparation of a hardening accelerator composition by reaction of a water-soluble calcium compound with a water-soluble silicate compound in the presence of an aqueous solution which contains a water-soluble comb polymer suitable as a plasticizer for hydraulic binders, e.g. a polycarboxylate ether (PCE).

WO 2018/154013 describes an oxidic composition, comprising at least 95 wt.-% of calcium oxide and silicon oxide having a molar ratio of Ca/Si in the range of from 0.5 to 2.5. The oxidic composition contains a semi-ordered calcium silicate hydrate having an apparent crystallite size of 15 nm or less, and less than 35 wt.-% of crystalline phases that are different from the semi-ordered calcium silicate hydrate. The oxidic composition can be converted into a curing-accelerator composition which is particularly suitable for hydraulic or latently hydraulic binding agents.

US 2020/0231499 describes a curing accelerator composition for building chemical mixtures comprising a mineral constituent and a polymeric water-soluble dispersant. The mineral constituent comprises a semi-ordered calcium silicate hydrate having an apparent crystallite size of 15 nm or less and less than 35 wt.-% of crystalline phases other than the semi-ordered calcium silicate hydrate. The composition displays a more pronounced accelerating effect than comparative compositions in which the mineral component comprises a calcium silicate hydrate having a higher degree of crystallinity.

WO 2018/122091 describes a strength enhancing admixture for cementitious and/or pozzolanic compositions including calcium silicate hydrate, at least one alkanolamine, at least one inorganic accelerator, and at least one carbohydrate. The calcium silicate hydrate includes a product of a reaction of a water-soluble calcium compound with a water-soluble silicate compound in the presence of a water-soluble dispersant. The inorganic accelerator includes any inorganic accelerator(s) other than calcium silicate hydrate.

Generally, the above hardening accelerator compositions have a good accelerating effect. However, due to the future demand for further reducing the amount of cement, a more pronounced hardening acceleration together with improved compressive strength would be favorable as can be obtained with the presently known hardening accelerator compositions. Thus, there remains a need for hardening accelerator compositions which allow for such more pronounced hardening acceleration of cement.

It is therefore an object of the present invention to provide a hardening accelerator composition allowing for excellent hardening acceleration and compressive strength of cement.

The object of the present invention is solved by a hardening accelerator composition for cementitious compositions, comprising
(a) a C—S—H seed component comprising a finely dispersed mineral constituent stabilized by a polymeric water-soluble dispersant, the mineral constituent comprising a semi-ordered calcium silicate hydrate having an apparent crystallite size of 15 nm or less, and
(b) an alkanolamine selected from diethanolamine (DEA) and methyl diethanolamine (MDEA), or mixtures thereof.

Herein, the expression “comprising” or “comprises” also encompasses the expressions “consisting essentially of” and “consisting of” without being synonymous with these expressions.

It has been found that a hardening accelerator composition comprising a C—S—H seed component and certain alkanolamines allows for a greater hardening acceleration and promotion of compressive strength development of cement than either agent alone. Said improvement in compressive strength is favorable in view of reducing the amount of cement or to improve production efficiency accompanied by reducing production time.

Without wishing to be bound by theory, we believe that the alkanolamine(s) (b) are able to accelerate the aluminate reaction in cement and the C—S—H seed component (a) is able to stimulate the nucleation and precipitation of calcium silicate hydrate during the initial hours of hydration reaction.

In an embodiment, the hardening accelerator composition comprises a synergistically active ratio of the C—S—H seed component (a) and the alkanolamine (b). By synergism is meant in this connection an increased overall effect which exceeds, in the desired direction, the purely cumulative individual effects of the C—S—H seed component (a) and the alkanolamine (b).

In an embodiment, the hardening accelerator composition has a weight ratio of the alkanolamine (b) to the C—S—H seed component (a) is in the range of from 0.07 to 2.4, preferably 0.07 to 1.89, more preferably 0.19 to 0.5, calculated on a solids basis.

In an embodiment, the mineral constituent comprises a molar ratio of calcium to silicon in the range of from 0.5 to 2.5, preferably 0.8 to 2.2, more preferably 1.0 to 2.0, most preferably between 1.0 and 1.8.

In an embodiment, the polymeric water-soluble dispersant is a polymer having a carbon-containing backbone to which pendant cement-anchoring groups and polyether side chains are attached.

In an embodiment, the weight ratio of the mineral constituent to the polymeric water-soluble dispersant in the C—S—H seed component (a) is in the range of from 1:1 to 5:1, preferably 2:1 to 3:1, calculated on a solids basis. In view of storage stability and ease of handling, the C—S—H seed component (a) preferably comprises 2 to 30%, preferably 5 to 25%, more preferably 8 to 20% of the mineral constituent, and preferably 1 to 15%, more preferably 2 to 12%, most preferably 3 to 10% of the polymeric water-soluble dispersant, the remainder being water.

The invention further relates to a cementitious composition, comprising a cementitious binder and the hardening accelerator composition as described above.

In an embodiment, the cementitious composition comprises 0.29 to 0.51% of the C—S—H seed component (a), and 0.03 to 0.70% of the alkanolamine (b), calculated on a solids basis by weight of the cementitious binder.

In an embodiment, the cementitious binder is Portland cement, preferably Ordinary Portland Cement (OPC).

In an embodiment, the cementitious composition further comprises an aggregate, selected from sand and coarse aggregate.

In an embodiment, the cementitious composition further comprises an additional amount of a dispersant.

In an embodiment, the cementitious composition comprises 10 to 25%, preferably 12 to 20% of the cementitious binder, calculated on a solids basis by weight of the total amount of the cementitious composition.

In an embodiment, the cementitious composition exhibits a 6-hour compressive strength according to DIN EN 196-1 of at least 10 MPa, preferably 20 MPa, at 8° C.

The invention further relates to a process for accelerating the hardening of a cementitious composition comprising a cementitious binder, the process comprising adding the hardening accelerator composition as described above to the cementitious composition.

Mineral Constituent comprising a semi-ordered Calcium Silicate Hydrate

The mineral constituent of the C—S—H seed component comprises a semi-ordered calcium silicate hydrate. Herein, “semi-ordered” means that the calcium silicate hydrate has a degree of order that lies intermediate between those of a macroscopic crystalline calcium silicate hydrate and amorphous calcium silicate hydrate. Semi-ordered calcium silicate hydrate has physical properties which differ both from the pure crystalline form and from the pure amorphous form.

The semi-ordered calcium silicate hydrate has a long-range order of less than 100 repeating units, usually less than 20 repeating units, of the unit cell in at least one direction in space. If the coherently scattering regions (crystallites), which correspond to the repeating units of the unit cell, are very small in a sample, the individual crystallites which are actually present in the reflection plane are often slightly tilted relative to one another. In addition, the disruption of the structure at the grain boundaries results in changes in the diffraction behavior. The angle range in which reflection and thus a diffraction signal still occurs is broadened thereby.

One suitable method for determining whether a calcium silicate hydrate is present in semi-ordered form employs X-ray diffraction. Diffraction patterns of the calcium silicate hydrate can be recorded using a commercial powder diffractometer. The X-ray diffraction pattern of the semi-ordered calcium silicate hydrate differs from the X-ray diffraction pattern of a crystalline calcium silicate hydrate. Semi-ordered calcium silicate hydrate displays a diffraction pattern in which the reflections or diffraction lines or “peaks” are broader or less well-defined and/or partly absent compared to the diffraction pattern of the crystalline form. In the following, a “peak” is a maximum in the plot of the X-ray diffraction intensity against the diffraction angle. The main diffraction peak of the semi-ordered calcium silicate hydrate has, for example, a width at half height which is at least 1.25 times, usually at least 2 times or at least 3 times, the width at half height of the corresponding main diffraction peak of the crystalline form having a crystallite size of 50 nm or more.

Furthermore, the X-ray diffraction pattern of the semi-ordered calcium silicate hydrate also differs from the purely X-ray-amorphous form. The X-ray diffraction pattern of the semi-ordered calcium silicate hydrate displays few broad phase-specific X-ray diffraction maxima which indicate a certain degree of order of the calcium silicate hydrate, while the X-ray-amorphous form displays no distinguishable X-ray diffraction maxima. No calcium silicate hydrate phase can be assigned unambiguously to the X-ray-amorphous form.

An “apparent” crystallite size can be calculated by the method of Scherrer from the widths at half height of X-ray diffraction signals:

$$β = λ / ϵ cos θ$$

with
β=width at half height
λ=wavelength
ϵ=apparent crystallite size
θ=Bragg angle

In practice, the “whole pattern fitting structure refinement (PFSR)” of Hugo Rietveld (“Rietveld analysis”) has been found to be useful for evaluating the diffraction pattern. This software method serves to refine a number of measurement parameters, including lattice parameters, signal width and signal shape. Theoretical diffraction patterns can be calculated in this way. As soon as the calculated diffraction pattern is virtually identical to the data of an unknown sample, precise quantitative information as to crystallite size and amorphous content can be determined.

The semi-ordered calcium silicate hydrate has an apparent crystallite size of 15 nm or less, preferably 10 nm or less, more preferably 5 nm or less, determined by means of X-ray diffraction analysis and subsequent Rietveld analysis. The apparent crystallite size is generally at least 1 nm, e.g. from 1 to 15 nm, or from 1 to 10 nm and particularly preferably from 1 to 5 nm.

The unit cells of the ordered regions of the semi-ordered calcium silicate hydrate, the size of which is described with the aid of their apparent crystallite size in the present patent application, are derived from crystalline calcium silicate hydrate phases (C—S—H). Crystalline calcium silicate hydrate phases are, in particular, foshagite, hillebrandite, xonotlite (belovite), xonotlite (kudohite), nekoite, clinotobermorite, 9 Å-tobermorite (riversiderite), 10 Å-tobermorite, 11 Å-tobermorite (C/S 0.75 and 0.66), 14 Å-tobermorite (plombierite), jennite, metajennite, calcium chondrodite, afwillite, α-C2SH, dellaite, jaffeite, rosenhahnite, killalaite, bultfonteinite, reinhardbraunsite, kilchoanite, C8S5, okenite, reyerite, gyrolith, truscottite, K-phase, Z-phase, scawtite, fukalite, tylleite, spurrite and/or suolunite, preferably as xonotlite, 9 Å-tobermorite (riversiderite), 11 Å-tobermorite, 14 Å-tobermorite (plombierite), jennite, metajennite, afwillite and/or jaffeite.

The unit cells of the ordered regions are preferably derived from 9 Å-tobermorite (riversiderite), 10 Å-tobermorite, 11 Å-tobermorite (C/S 0.75 and 0.66), 14 Å-tobermorite (plombierite), scawtite and/or xonotlite, and mixtures thereof.

For the present purposes, it has been found to be a sufficient approximation for the determination of the apparent crystallite size to be based exclusively on the unit cell of 14 Å-tobermorite (plombierite).

The mineral constituent preferably comprises at least 95 wt.-%, more preferably at least 98 wt.-%, based on the dry weight of the mineral constituent, of calcium oxide (CaO) and silicon oxide (SiO₂). The molar ratio of Ca/Si in the mineral constituent is preferably in the range from 0.5 to 2.5, more preferably from 0.8 to 2.2, most preferably from 1.0 to 2.0 or from 1.6 to 2.0.

Owing to production-related impurities, the mineral constituent can comprise small amounts of aluminum ions, with the molar ratio of silicon/aluminum in the mineral constituent being from 10000:1 to 2:1, preferably from 1000:1 to 5:1 and more preferably from 100:1 to 10:1. In the case of contamination with aluminum, the mineral constituent can also comprise aluminum-comprising phases such as gibbsite (Al(OH)₃).

Preference is given to no foreign ions such as alkali metal ions, chloride ions or nitrate ions or only a very small amount of foreign ions being introduced into the composition via the mineral constituent.

Preferably, the mineral constituent comprises less than 35 wt.-%, based on the dry weight of the mineral constituent, of crystalline phases of portlandite (Ca(OH)₂), calcite (CaCO₃), aragonite (CaCO₃), vaterite (CaCO₃) and α-quartz (SiO₂). The content of crystalline foreign phases can be in the range from 0.1 to less than 35 wt.-%, preferably from 1 to 25 wt.-%, based on the dry weight of the mineral constituent. The dry weight is determined by drying the mineral constituent to constant weight at 105° C.

The mineral constituent typically also comprises an X-ray-amorphous phase in addition to the semi-ordered calcium silicate hydrate (and possibly crystalline foreign phases). In one embodiment, the mineral constituent comprises at least 10 wt.-%, preferably 40 wt.-%, more preferably 60 wt.-% and in particular from 10 to 99.9 wt.-% or from 10 to 80 wt.-%, preferably from 40 to 80 wt.-%, of X-ray-amorphous phase, based on the dry weight of the mineral constituent, determined by means of X-ray diffraction analysis and subsequent Rietveld analysis.

The sum of semi-ordered calcium silicate hydrate and X-ray-amorphous phase is preferably at least 65 wt.-%, e.g. from 65 to 99 wt.-%, based on the dry weight of the mineral constituent, determined by means of X-ray diffraction analysis and subsequent Rietveld analysis.

The mineral constituent can be obtained by reaction of a calcium hydroxide source, e.g. calcium oxide or calcium hydroxide, with a silicon dioxide source, e.g. silicon dioxide, under hydrothermal conditions, i.e., in the presence of water and at an elevated temperature of at least 100° C. and elevated pressure, advantageously in an autoclave. Here, the mineral constituent is obtained as solid with physically adsorbed water. Apart from optional drying at a temperature of about 105° C., it is not subjected to any further thermal treatment. The mineral constituent produced in this way comprises semi-ordered calcium silicate hydrate, crystalline foreign phases including the unreacted crystalline foreign phases or the crystalline foreign phases formed in the reaction, e.g. quartz, portlandite, calcite, etc., and also X-ray-amorphous phases.

The production of the mineral constituent is advantageously carried out in a closed vessel, for example an autoclave, preferably at a temperature in the range from 100 to 400° C., in particular from 110 to 300° C. or from 110 to 230° C. or from 130 to 200° C. or from 130 to 180° C. or from 155 to 180° C. or from 160 to 180° C., and a pressure resulting therefrom. As calcium oxide or calcium hydroxide, it is possible to use, for example, quicklime, slacked lime, etc. Examples of suitable types of silicon dioxide are silica sand or quartz flour, microsilica, etc. Furthermore, pozzolanic binders such as flyashes, slags such as blast furnace slag, and/or metakaolins can also be used as starting materials. In order to assist the reaction and shorten the reaction time, the starting materials are generally used with an average particle size of <1 mm. The silicon dioxide source generally has a particle size d(99) in the range from 1 to 100 μm, in particular from 1 to 90 μm. The amount of calcium oxide or calcium hydroxide and silicon dioxide is generally selected so that the molar ratio of Ca/Si in the mineral constituent is in the range from 0.5 to 2.5, preferably from 0.8 to 2.2, more preferably from 1.0 to 2.0.

It has been found to be advantageous to use a foaming agent, in particular aluminum powder or a paste comprising metallic aluminum, in the hydrothermal production of the mineral constituent.

The mineral constituent is comminuted after the hydrothermal synthesis. Conventional apparatuses such as crushers and ball mills are suitable for this purpose. Comminution is carried out until a particle size (d(97)) of 5 mm, preferably 2 mm and in particular a particle size (d(97)) in the range of from 0.05 to 5 mm, preferably 0.1 to 2 mm, in particular 0.3 to 1 mm, is attained. Comminution is carried out at a temperature of 80° C., preferably 60° C., more preferably 50° C.

The mineral constituent which is brought into contact with the polymeric dispersant preferably has a specific BET surface area in the range from 30 to 150 m²/g, preferably from 80 to 150 m²/g, in particular from 90 to 150 m²/g, particularly preferably from 100 to 150 m²/g, determined in accordance with DIN ISO 9277:2003-05.

### Polymeric Water-Soluble Dispersant

The polymeric water-soluble dispersant used to stabilize the fine dispersion of the mineral constituent in the C—S—H seed component may be any dispersant, mostly an ionic or non-ionic polymer, also known as fluidity modifier or slump modifier, which is introduced into freshly mixed concrete to improve the workability of the concrete while reducing the amount of water needed for purposes of transportation, pouring and placing the concrete.

For the present purposes, a “water-soluble dispersant” is an organic water-soluble polymeric dispersant, i.e. it is an organic polymer which at 20° C. and atmospheric pressure has a solubility in water of at least 1 g/L, preferably at least 10 g/L, more preferably at least 100 g/L.

In an embodiment, the polymeric water-soluble dispersant is selected from
polycarboxylate ethers,
phosphorylated polycondensates being obtainable by a condensation reaction of an aromatic compound having a phosphate moiety, an alkoxylated hydroxyaryl compound having a polyoxyalkylene chain, and formaldehyde,
non-ionic polymers having a carbon-containing backbone to which are attached pendant hydrolysable groups and polyether side chains, the hydrolysable groups upon hydrolysis releasing ionic anchoring groups,
sulfonated melamine-formaldehyde condensates,
lignosulfonates,
sulfonated ketone-formaldehyde condensates,
sulfonated naphthalene-formaldehyde condensates,
phosphonate containing dispersants, and
mixtures thereof.

In a preferred embodiment, the dispersant is selected from polycarboxylate ethers and phosphorylated polycondensates being obtainable by a condensation reaction of an aromatic compound having a phosphate moiety, an alkoxylated hydroxyaryl compound having a polyoxyalkylene chain, and formaldehyde.

The polycarboxylate ether has a carbon-chain backbone with anionic and/or anionogenic groups and polyoxyalkylene side chains having an average of 3 to 130 oxyalkylene units. The polycarboxylate ethers may be prepared by free radical polymerization of suitable α, β-ethylenically unsaturated monomers.

Anionogenic groups are the acid groups present in the polycarboxylate ether, which can be transformed to the respective anionic group under alkaline conditions.

Preferably, the anionic and anionogenic groups are carboxyl, carboxylate or phosphate groups, hydrogenphosphate or dihydrogenphosphate groups.

The polycarboxylate ether preferably comprises structural units of formulae (Ia), (Ib), (Ic) and/or (Id), which impart may anionic and/or anionogenic groups. The formulae (Ia), (Ib), (Ic) and/or (Id) may be identical or different both within individual polymer molecules and between different polymer molecules.

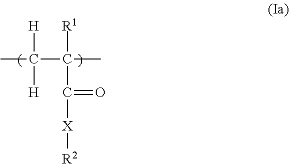

wherein
R¹ is H, C₁-C₄ alkyl, CH₂COOH or CH₂CO—X—R^{3A}, preferably H or methyl;
X is NH—(Cₙ₁H₂ₙ₁) or O—(Cₙ₁H₂ₙ₁) with n1=1, 2, 3 or 4, the nitrogen atom or the oxygen atom being bonded to the CO group;
R² is OM, PO₃M₂, or O—PO₃M₂; or
X is a chemical bond and R² is OM;
R^{3A} is PO₃M₂, or O—PO₃M₂;

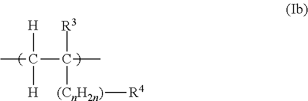

wherein
R³ is H or C₁-C₄ alkyl, preferably H or methyl;
n is 0, 1, 2, 3 or 4;
R⁴ is PO₃M₂, or O—PO₃M₂;

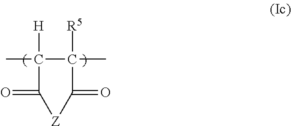

wherein
R⁵ is H or C₁-C₄ alkyl, preferably H;
Z is O or NR⁷:
R⁷ is H, (Cₙ₁H₂ₙ₁)—OH, (Cₙ₁H₂ₙ₁)—PO₃M₂, (Cₙ₁H₂ₙ₁)—OPO₃M₂, (C₆H₄)—PO₃M₂, or (C₆H₄)—OPO₃M₂, and
n1 is 1,2,3 or 4;

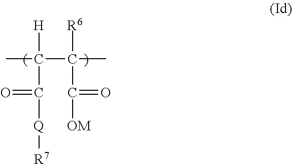

wherein
R⁶ is H or C₁-C₄ alkyl, preferably H;
Q is NR⁷ or O;
R⁷ is H, (Cₙ₁H₂ₙ₁)—OH, (Cₙ₁H₂ₙ₁)—PO₃M₂, (Cₙ₁H₂ₙ₁)—OPO₃M₂, (C₆H₄)—PO₃M₂, or (C₆H₄)—OPO₃M₂,
n1 is 1, 2, 3 or 4; and

where each M independently is H or a cation equivalent.

Preferably, the polycarboxylate ether comprises structural units of the formula (Ia) wherein R¹ is H or methyl; and/or at least one structural unit of the formula (Ib) wherein R³ is H or methyl; and/or at least one structural unit of the formula (Ic) wherein R⁶ is H or methyl and Z is O; and/or at least one structural unit of the formula (Id) wherein R⁶ is H and Q is 0.

Preferably, the polycarboxylate ether comprises as structural units of the formula (Ia) wherein R¹ is H or methyl and XR² is OM or X is O(CₙH₂ₙ) with n1=1, 2, 3 or 4, more particularly 2, and R² is O—PO₃M₂.

With particular preference, the structural unit of formula (Ia) is a methacrylic acid or acrylic acid unit, the structural unit of formula (Ic) is a maleic anhydride unit, and the structural unit of formula (Id) is a maleic acid or maleic monoester unit.

In the case that the monomers (I) are phosphoric esters or phosphonic esters, they may also include the corresponding diesters and triesters and also the monoester of diphosphoric acid. In general, these esters come about during the esterification of organic alcohols with phosphoric acid, polyphosphoric acid, phosphorus oxides, phosphorus halides or phosphorus oxyhalides, and/or the corresponding phosphonic acid compounds, alongside the monoester, in different proportions, as for example 5 to 30 mol-% of diester and 1 to 15 mol-% of triester and also 2 to 20 mol-% of the monoester of diphosphoric acid.

The polycarboxylate ether may comprise structural units of the formulae (IIa), (IIb), (IIc) and/or (IId), which impart polyether side chains. The formulae (IIa), (IIb), (IIc) and/or (IId) may be identical or different not only within individual polymer molecules but also between different polymer molecules. All structural units A as defined below may be identical or different both within individual polyether side chains and between different polyether side chains.

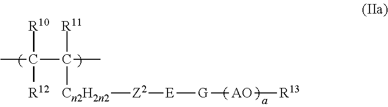

wherein
R¹⁰, R¹¹ and R¹² independently of one another are H or C₁-C₄ alkyl, preferably H or methyl;
Z² is O or S;
E is C₂-C₆ alkylene, cyclohexylene, CH₂—C₆H₁₀, 1,2-phenylene, 1,3-phenylene or 1,4-phenylene;
G is O, NH or CO—NH; or
E and G together are a chemical bond;
A is C₂-C₅ alkylene or CH₂CH(C₆H₅), preferably C₂-C₃ alkylene;
n2 is 0, 1, 2, 3, 4 or 5;
a is an integer from 3 to 130;
R¹³ is H, an unbranched or branched C₁-C₄ alkyl group, CO—NH₂ or COCH₃; Preferably, the structural unit of formula (IIa) is an alkoxylated isoprenyl unit, alkoxylated hydroxybutyl vinyl ether unit, alkoxylated (meth)allyl alcohol unit or a vinylated methylpolyalkylene glycol unit, in each case preferably with an arithmetic average of 3 to 130 oxyalkylene groups.

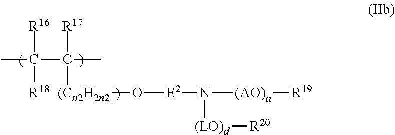

wherein
R¹⁶, R¹⁷ and R¹⁸ independently of one another are H or C₁-C₄ alkyl, preferably H;
E² is C₂-C₆ alkylene, cyclohexylene, CH₂—C₆H₁₀, 1,2-phenylene, 1,3-phenylene, or 1,4-phenylene, or is a chemical bond;
A is C₂-C₅ alkylene or CH₂CH(C₆H₅), preferably C₂-C₃ alkylene;
n2 is 0, 1, 2, 3, 4 or 5;
L is C₂-C₅ alkylene or CH₂CH(C₆H₅), preferably C₂-C₃ alkylene;
a is an integer from 3 to 130;
d is an integer from 3 to 130;
R¹⁹ is H or C₁-C₄ alkyl; and
R²¹ is H or C₁-C₄ alkyl;

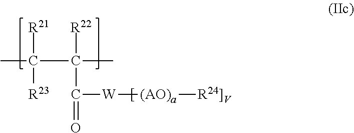

wherein
R²¹, R²² and R²³ independently are H or C₁-C₄ alkyl, preferably H;
W is O, NR²⁵, or is N;
V is 1 if W═O or NR²⁵, and is 2 if W═N;
A is C₂-C₅ alkylene or CH₂CH(C₆H₅), preferably C₂-C₃ alkylene;
a is an integer from 3 to 130;
R²⁴ is H or C₁-C₄ alkyl;
R²⁵ is H or C₁-C₄ alkyl;

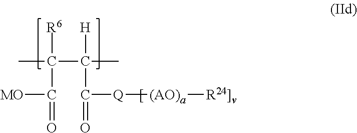

wherein
R⁶ is H or C₁-C₄ alkyl, preferably H;
Q is NR¹⁰, N or O;
V is 1 if Q=O or NR¹⁰ and is 2 if Q=N;
R¹⁰ is H or C₁-C₄ alkyl;
R²⁴ is H or C₁-C₄ alkyl;
A is C₂-C₅ alkylene or CH₂CH(C₆H₅), preferably C₂-C₃ alkylene; and
a is an integer from 3 to 130;
where each M independently is H or a cation equivalent.

Besides the structural units of the formulae (I) and (II), the polycarboxylate ether may also comprise further structural units, which are derived from radically polymerizable monomers, such as hydroxyethyl (meth)acrylate, hydroxypropyl (meth)acrylate, (meth)acrylamide, (C₁-C₄) alkyl (meth)acrylates, styrene, styrenesulfonic acid, 2-acrylamido-2-methylpropanesulfonic acid, (meth)allylsulfonic acid, vinylsulfonic acid, vinyl acetate, acrolein, N-vinylformamide, vinylpyrrolidone, (meth)allyl alcohol, isoprenol, 1-butyl vinyl ether, isobutyl vinyl ether, aminopropyl vinyl ether, ethylene glycol monovinyl ether, 4-hydroxybutyl monovinyl ether, (meth)acrolein, crotonaldehyde, dibutyl maleate, dimethyl maleate, diethyl maleate, dipropyl maleate, etc.

The polycarboxylate ether comprising the structural units (I) and (II) may be prepared by conventional methods, for example by free radical polymerization or controlled radical polymerization as, e.g., described in EP 0 894 811, EP 1 851 256, EP 2 463 314, and EP 0 753 488.

Suitably, such polycarboxylate ether has a weight-average molecular weight of 5000 to 200000 g/mol, preferably 10000 to 80000 g/mol, more preferably 20000 to 70000 g/mol. The weight-average molecular weight is preferably measured by gel permeation chromatography (GPC) according to the details given in the experimental part (methods).

Preferably, the polycarboxylate ether comprises:
(a) at least one structural unit of the formula (IIa) wherein R¹⁰ and R¹² are H, R¹¹ is H or methyl, E and G together are a chemical bond, A is C₂-C₃ alkylene, a is 3 to 130, and R¹³ is H or an unbranched or branched C₁-C₄ alkyl group; and/or
(b) at least one structural unit of the formula (IIb) wherein R¹⁶ and R¹⁸ are H, R¹⁷ is H or methyl, E² is an unbranched or branched C₂-C₆ alkylene group, A is C₂-C₃ alkylene, L is C₂-C₃ alkylene, a is an integer from 3 to 130, d is an integer from 3 to 130, R¹⁹ is H or an unbranched or branched C₁-C₄ alkyl group, and R²⁰ is H or an unbranched or branched C₁-C₄ alkyl group; and/or
(c) at least one structural unit of the formula (IIc) wherein R²¹ and R²³ are H, R²² is H or methyl, A is C₂-C₃ alkylene, a is an integer from 3 to 130, and R²⁴ is H or an unbranched or branched C₁-C₄ alkyl group; and/or
(d) at least one structural unit of the formula (IId) wherein R⁶ is H, Q is O, A is C₂-C₃ alkylene, and a is an integer from 3 to 130.

The polycarboxylate ether may comprise at least one structural unit of the formula (IIa) and/or (IIc).

The polycarboxylate ether may comprise structural units of the formulae (I) and (II), e.g. of the formulae (la) and (IIa), or of the formulae (la) and (IIc), or of the formulae (Ic) and (IIa), or of the formulae (la), (Ic) and (IIa).

Preferably, the polycarboxylate ether may comprise units of (I) and (II) according to embodiments 1 to 3 of the following table:

| # | (I) | (II) |
|---|---|---|
| 1 | hydroxyethyl acrylate | C₁-C₄ alkyl-polyethylene glycol |
| | phosphoric acid ester | acrylic acid ester and/or C₁-C₄ alkyl- |
| | and/or hydroxyethyl | polyethylene glycol methacrylic acid |
| | methacrylate phosphoric | ester |
| | acid ester | |
| 2 | acrylic acid and/or | C₁-C₄ alkyl-polyethylene glycol |
| | methacrylic acid | acrylic acid ester and/or C₁-C₄ alkyl- |
| | | polyethylene glycol methacrylic acid |
| | | ester |
| 3 | acrylic acid, methacrylic | vinyloxy-C₂-C₄ alkylene-polyethylene |
| | acid and/or | glycol, allyloxy-polyethylene glycol, |
| | maleic acid | methallyloxy-polyethylene glycol |
| | | and/or isoprenyloxy-polyethylene |
| | | glycol |

More preferably, the polycarboxylate ether may comprise units of (I) and (II) according to embodiments 4 to 13 of the following table:

| # | (1) | (II) |
|---|---|---|
| 4 | hydroxyethyl | C₁-C₄ alkyl-polyethylene glycol |
| | methacrylate | methacrylic acid ester or |
| | phosphoric acid | polyethylene glycol methacrylic |
| | ester | acid ester |
| 5 | methacrylic | C₁-C₄ alkyl-polyethylene glycol |
| | acid | methacrylic acid ester or |
| | | polyethylene glycol methacrylic |
| | | acid ester |
| 6 | acrylic acid and | vinyloxy-C₂-C₄ alkylene- |
| | maleic acid | polyethylene glycol |
| 7 | acrylic acid and | isoprenyloxy-polyethylene glycol |
| | maleic acid | |
| 8 | acrylic acid | vinyloxy-C₂-C₄ alkylene- |
| | | polyethylene glycol |
| 9 | acrylic acid | isoprenyloxy-polyethylene glycol |
| 10 | acrylic acid | methallyloxy-polyethylene glycol |
| 11 | maleic acid | isoprenyloxy-polyethylene glycol |
| 12 | maleic acid | allyloxy-polyethylene glycol |
| 13 | maleic acid | methallyloxy-polyethylene glycol |

Suitably, the molar ratio of structural units (I) to structural units (II) varies from 1:3 to about 10:1, preferably 1:1 to 10:1, more preferably 3:1 to 6:1.

The polycarboxylate ether may be an aqueous product in the form of a solution, emulsion or dispersion or in solid form, for example as a powder, after a drying step. In the latter case, the water content is preferably less than 10 wt.-%, more preferably less than 5 wt.-%. Suitably, a part of the water, e.g. at least 10 wt.-%, may be replaced by organic solvents, e.g. alcohols such as ethanol, (iso)propanol and 1-butanol, including its isomers, or ketones such as acetone. By the use of the organic solvents, it is possible to influence the solubility and hence the crystallization behavior of the polycarboxylate ether.

The polycarboxylate ether may have a charge density of 0.5 to 2.7 meq/g, preferably 0.7 to 2.5 meq/g, of polymer. The milliequivalent number refers to carboxyl groups or carboxyl groups releasable from anionogenic groups contained in these components, assuming that all carboxyl groups are in unneutralized form.

The phosphorylated polycondensate is obtainable by a condensation reaction of
(1) an aromatic compound having a phosphate moiety,
(2) an alkoxylated hydroxyaryl compound having a polyoxyalkylene chain with 3 to 130 oxyalkylene units, and
(3) formaldehyde,

in a weight ratio of (1):(2) of 2:98 to 40:60, preferably 5:95 to 30:70, more preferably 10: 90 to 20: 80.

The aromatic compound having a phosphate moiety (I) may be represented by formula (II):

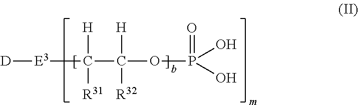

wherein, in formula (II),
D is a substituted or unsubstituted aromatic or heteroaromatic compound having 5 to 10 carbon atoms,
E³ is N, NH or O,
m=2 if E³=N and m=1if E³=NH or O,
R³¹ and R³², independently of one another, are identical or different and are represented by a branched or straight-chain C₁- to C₁₀-alkyl radical, C₅- to C₈-cycloalkyl radical, aryl radical, heteroaryl radical or H, and b are identical or different and are represented by an integer from 0 to 300.

Suitably, moiety D is represented by phenyl, 2-hydroxy-,phenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxy-,naphthyl, 4-methoxynaphthyl, preferably phenyl.

Preferably, moiety E³ is represented by O.

Suitably, the substituents R³¹ and R³² may be chosen independently of one another and are preferably represented by H, methyl, ethyl or phenyl, more preferably by H or methyl, most preferably by H.

Suitably, b is an integer from 0 to 10, preferably 1 to 7, more preferably 1 to 5. The respective substituents, the length of which is defined by b, may consist of uniform building blocks, but a mixture of different building blocks may also be expedient.

Furthermore, the substituents may each have the same chain length, b being represented by a number. As a rule, however, it will be expedient if mixtures having different chain lengths are present in each case so that the radicals of the monomers or structural units in the polycondensate have different numerical values for b.

The alkoxylated hydroxyaryl compound (2) is a hydroxyaryl compound having a polyoxyalkylene chain with 3 to 130, preferably 5 to 100, more preferably 8 to 80 oxyalkylene units.

Herein, the term “alkoxylated hydroxyaryl compound” denotes a compound having an aromatic core and at least one hydroxyl group directly attached to the aromatic core. The alkoxylated hydroxyaryl compound (2) may have one or more further substituents as long as the presence of such substituents does not interfere with the condensation reaction of the alkoxylated hydroxyaryl compound (2) and formaldehyde (3). In an embodiment, the hydroxyaryl compound (2) is selected from unsubstituted or monosubstituted phenols, and unsubstituted or monosubstituted naphthols. Suitably, the phenols and naphthols may be monosubstituted with a substituent selected from alkyl groups and carboxylic groups. Suitable naphthols are selected from 1-naphthol and 2-naphthol. Suitable alkyl-substituted phenols are selected from ortho-cresol, meta-cresol and para-cresol. Suitable carboxylic-substituted phenols are selected from gallic acid and salicylic acid.

Herein, the term “oxyalkylene units” refers to a repeating unit of general formula (A-1):

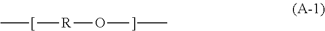

wherein R denotes a linear or branched alkylene unit having at least 2 carbon atoms, preferably 2 to 4 carbon atoms. The polyoxyalkylene chain may comprise identical or different oxyalkylene units. Different oxyalkylene units may be arranged either in a random or a block-wise fashion. Preferably, the oxyalkylene unit is an oxyethylene group (—CH₂—CH₂—O—) and/or an oxypropylene group (—CH(CH₃)—CH₂—O— and/or —CH₂—CH(CH₃)—O—), preferably an oxyethylene group.

The alkoxylated hydroxyaryl compounds (2) may be obtained by reaction of hydroxyaryl compounds with alkylene oxides such as ethylene oxide or propylene oxide. The alkylene oxides introduce one or more divalent oxyalkylene groups into the hydroxyaryl compounds, e.g. into the phenol molecule. Such alkylene oxide residue is then interposed between the hydroxyl group oxygen atom and its hydrogen atom.

Generally, such an alkoxylated compound may be a single compound. However, usually, it is a mixture of compounds in which the numbers of oxyalkylene groups in the compounds are present as a distribution. That is that the number of 3 to 130 oxyalkylene units per polyoxyalkylene chain represents an average value of oxyalkylene units per polyoxyalkylene chain.

In an embodiment, the polyoxyalkylene units comprise at least 60 mol-%, preferably at least 85 mol-%, more preferably at least 95 mol-% of oxyethylene units.

In an embodiment, the alkoxylated hydroxyaryl compound (2) is an ethoxylated phenol. The term “ethoxylated phenol” denotes a hydroxyaryl compound that has been reacted with ethylene oxide to yield a polyoxyalkylene chain consisting of 100% oxyethylene units.

Suitably, such ethoxylated phenol is prepared by an ethoxylation reaction of phenol, or phenoxyethanol using ethylene oxide. Generally, such a phenoxyethanol precursor may be produced by a hydroxyethylation reaction of phenol using ethylene oxide, e.g. by a Williamson ether synthesis. Said phenoxyethanol precursor carries a hydroxyethyl moiety at the phenolic hydroxyl group oxygen atom at which a (poly)-oxyethylene chain may subsequently be attached.

That is, for the preparation of the phosphorylated polycondensate, components (1) and (2) are reacted with formaldehyde (3). Suitably, the formaldehyde (3) is added in form of a 37% formaldehyde solution in water. Formaldehyde (3) is present in at least a stoichiometric amount, that is, formaldehyde (3) is used in a molar amount equal to the sum of the molar amounts of (1) and (2). Formaldehyde (3) may be used in excess of the stoichiometric amount.

Suitably, the phosphorylated polycondensate has a weight-average molecular weight of 4000 g/mol to 150000 g/mol, preferably 20000 to 75000 g/mol. The weight-average molecular weight is preferably measured by gel permeation chromatography (GPC)according to the details given in the experimental part (methods).

The condensation reaction of the compounds (1), (2) and (3) can be carried out according to processes known per se.

The phosphorylated polycondensate may be present as an aqueous solution containing 35 to 75 wt.-% of water and 25 to 65 wt.-% of dissolved dry matter, preferably 40 to 60 wt.-% of water and 40 to 60 wt.-% of dissolved dry matter, more preferably 45 to 55 wt.-% of water and 45 to 55 wt.-% of dissolved dry matter. The dry matter consists essentially of the anhydrous phosphorylated polycondensate.

The phosphate containing dispersant may have a charge density of 0.5 to 2.7 meq/g, preferably 0.7 to 2.5 meq/g, of polymer. The milliequivalent number refers to carboxyl groups or carboxyl groups releasable from anionogenic groups contained in these components, assuming that all carboxyl groups are in unneutralized form.

Suitable sulfonated melamine-formaldehyde condensates are of the kind frequently used as plasticizers for hydraulic binders (also referred to as MFS resins). Sulfonated melamine-formaldehyde condensates and their preparation are described in, for example, CA 2 172 004 A1, DE 44 1 1 797 A1, U.S. Pat. Nos. 4,430,469, 6,555,683 and CH 686 186 and also in Ullmann's Encyclopedia of Industrial Chemistry, 5th Ed., vol. A2, page 131, and Concrete Admixtures Handbook —Properties, Science and Technology, 2. Ed., pages 411, 412. Preferred sulfonated melamine-formaldehyde condensates encompass (greatly simplified and idealized) units of the formula (VI)

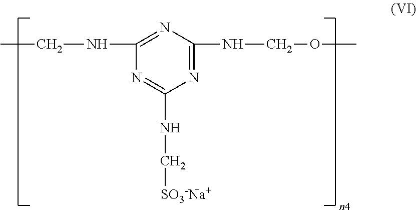

wherein n4 generally stands for 10 to 300. The molecular weight is situated preferably in the range from 2500 to 80000 g/mol. Additionally, to the sulfonated melamine units it is possible for other monomers to be incorporated by condensation. Particularly suitable is urea. Moreover, further aromatic units as well may be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. An example of melaminesulfonate-formaldehyde condensates are the Melment© products distributed by Master Builders Solutions Deutschland GmbH.

Suitable lignosulfonates are products which are obtained as by-products in the paper industry. They are described in Ullmann's Encyclopedia of Industrial Chemistry, 5th Ed., vol. A8, pages 586, 587. They include units of the highly simplified and idealizing formula (VII)

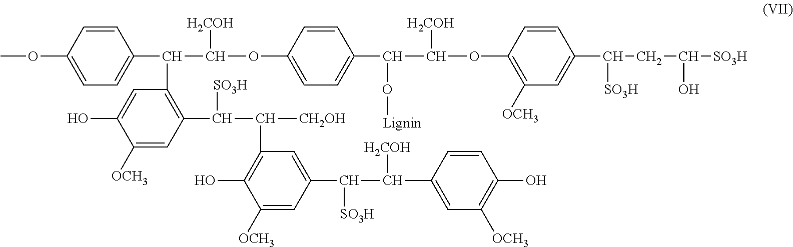

Lignosulfonates have molecular weights of between 2000 and 100000 g/mol. In general, they are present in the form of their sodium, calcium and/or magnesium salts. Examples of suitable lignosulfonates are the Borresperse products distributed by Borregaard LignoTech, Norway.

Suitable sulfonated ketone-formaldehyde condensates are products incorporating a monoketone or diketone as ketone component, preferably acetone, butanone, pentanone, hexanone or cyclohexanone. Condensates of this kind are known and are described in WO 2009/103579, for example. Sulfonated acetone-formaldehyde condensates are preferred. They generally comprise units of the formula (Vill) (according to J. Plank et al., J. Appl. Poly. Sci. 2009, 2018-2024):

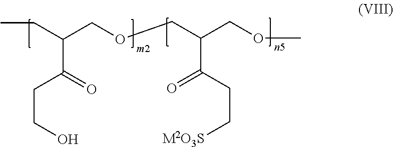

wherein m2 and n5 are generally each 10 to 250, M² is an alkali metal ion, such as Na*, and the ratio m2:n5 is in general in the range from about 3:1 to about 1:3, more particularly about 1.2:1 to 1:1.2. Furthermore, it is also possible for other aromatic units to be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. Examples of suitable sulfonated acetone-formaldehyde condensates are the Melcret K1L products distributed by Master Builders Solutions Deutschland GmbH.

Suitable sulfonated naphthalene-formaldehyde condensates are products obtained by sulfonation of naphthalene and subsequent polycondensation with formaldehyde. They are described in references including Concrete Admixtures Handbook —Properties, Science and Technology, 2. Ed., pages 411-413 and in Ullmann's Encyclopedia of Industrial Chemistry, 5th Ed., vol. A8, pages 587, 588. They comprise units of the formula (IX)

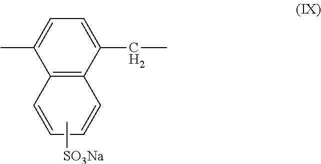

Typically, molecular weights (MW) of between 1000 and 50000 g/mol are obtained. Furthermore, it is also possible for other aromatic units to be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. Examples of suitable sulfonated p3-naphthalene-formaldehyde condensates are the Melcret 500 L products distributed by Master Builders Solutions Deutschland GmbH.

Generally, phosphonate containing dispersants incorporate phosphonate groups and polyether side groups.

Suitable phosphonate containing dispersants are those according to the following formula (X)

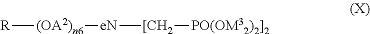

wherein
R is H or a hydrocarbon residue, preferably a C₁-C₁₅ alkyl radical,
A² is independently C₂-C₁₈ alkylene, preferably ethylene and/or propylene, most preferably ethylene,
n6 is an integer from 5 to 500, preferably 10 to 200, most preferably 10 to 100, and
M³ is H, an alkali metal, ½ alkaline earth metal and/or an amine.

C—S—H seed component

To produce the C—S—H seed component, the mineral constituent is brought into contact with at least one water-soluble polymeric dispersant in an aqueous medium.

For the contacting with the polymeric dispersant, the mineral constituent can be used in the form of a suspension or as dry powder. The polymeric dispersant is then added all at once or in two or more portions to the suspension comprising the mineral constituent, either as solid or in the form of an aqueous solution. However, the mineral constituent is preferably added all at once or in two or more portions as solid or as aqueous suspension to an aqueous solution of the polymeric dispersant.

In one embodiment, the weight ratio of the mineral constituent (calculated as dry component) to polymeric dispersant is in the range from 15:1 to 1:2, in particular in the range from 10:1 to 1:1.5, particularly preferably in the range from 5:1 to 1:1. In one embodiment, the weight ratio of mineral constituent (calculated as dry component) to water is in the range from 3:1 to 1:20, in particular in the range from 1:1 to 1:10, particularly preferably from 2:3 to 1:5.

The determination of the dry component of the mineral constituent is carried out by drying the material to constant weight at 105° C. in a laboratory oven and measuring the resulting loss in weight on drying.

The water content of the suspension (determined by drying the suspension to constant weight at 105° C.) in the contacting of the mineral constituent with the polymeric dispersant is appropriately in the range from 25 to 95 wt.-%, in particular in the range from 50 to 90 wt.-%, particularly preferably 60 to 80 wt.-%.

The contacting of the mineral constituent with the polymeric dispersant is carried out with introduction of kinetic energy, for example by mixing or milling. Virtually all devices known to a person skilled in the art are suitable for this purpose. Herein, mixing is blending or homogenization which intensifies contact of the components to be mixed and thus allows uniform and/or rapid formation of the desired product.

Methods which effect mixing are, for example, stirring, shaking, injection of gases or liquids and irradiation with ultrasound. Suitable methods and apparatuses which bring about mixing are known to a person skilled in the art. Suitable mixing apparatuses are, for example, stirred vessels, dynamic and static mixers, single-shaft stirring apparatuses, for example stirring apparatuses with scraping devices, in particular paste stirring apparatuses, multishaft stirring apparatuses, in particular PDSM mixers, solids mixers and mixing/kneading reactors.

In a preferred embodiment, contacting takes place with introduction of shearing energy, with more than 50 kWh, preferably more than 200 kWh, more preferably more than 400 kWh, especially from 100 to 5000 kWh, preferably 200 to 3000 kWh, more preferably 300 to 1000 kWh, of shearing energy being introduced per metric ton of the composition.

The shearing energy is defined as the effective work WW which can be calculated from the shearing power PW applied for milling and the milling time t according to the following equation (1):

$$WW = PW \cdot t \qquad ( 1 )$$

The shearing power which acts on the suspension can be calculated from the difference between effective power PP (power uptake of the apparatus during milling of the suspension) and the null power P0 (power uptake of the apparatus running empty without suspension and if applicable without milling media, e.g. in the case of a bead mill, ball mill or toothed colloid mill) by means of the following equation (2):

$$PW = PP - P 0 \qquad ( 2 )$$

The null power (equation (3a)) or the effective power (equation (3b)) can be calculated from the effective voltage U and the effective current I, which is measured by means of a current measuring instrument on the apparatus in operation:

$$P 0 = U 0 \cdot I 0 \cdot cos ϕ ; cos ϕ = 1 \qquad ( 3 a )$$

$$PP = UP \cdot IP \cdot cos ϕ ; cos ϕ = 1 \qquad ( 3 b )$$

The ratio of effective power PP to apparent power PS of the apparatus is described by cos φ according to equation (4):

$$cos ϕ = PP / PS \qquad ( 4 )$$

Since the apparent power is very apparatus-specific and the effective power can be measured easily (by measuring the effective voltage and the effective current), cos φ=1 is assumed in the interests of simplicity.

Preference is therefore given to processes which introduce a high shearing energy. Contacting is therefore particularly preferably carried out for at least part of the time using an apparatus from the group consisting of mills, ultrasonic apparatuses, rotor-stator mixers (e.g. IKA Ultra-Turrax) and high-speed mixers. In particular, the introduction of shearing energy can be carried out by milling, for example in a toothed colloid mill, bead mill, ball mill or preferably stirred ball mill. The stirred ball mill comprises a milling chamber in which the milling media are present, a stator and a rotor which are arranged in the milling chamber. Furthermore, the stirred ball mill preferably comprises an inlet opening for material being milled and an outlet opening for material being milled to effect introduction and discharge of material being milled into or from the milling chamber, and also a milling media separation device which is arranged upstream of the outlet opening in the milling chamber and serves to separate milling media carried with the material being milled from the material being milled before the latter is discharged from the milling space through the outlet opening.

In order to increase the mechanical milling power introduced into the material being milled in the milling chamber, pins which project into the milling space are preferably present on the rotor and/or on the stator. During operation, a contribution to the milling power is thus firstly produced directly by impacts between the material being milled and the pins. Secondly, a further contribution to the milling power is produced indirectly by impacts between the pins and the milling media entrained in the material to be milled and the subsequent impacts between the material being milled and the milling media. Finally, shear forces and tensile forces acting on the material being milled also contribute to comminution of the suspended particles of the material being milled.

In one embodiment, the contacting with the polymeric dispersant is carried out in two stages. In the first stage, contacting is carried out until the particle size d(99) of the mineral constituent is 300 μm and in particular is in the range of from 0.5 to 300 μm. This can be carried out using an apparatus selected from among a milling apparatus, an ultrasonic apparatus, a rotor-stator mixing system and a high-speed mixer disk.

In the second stage, contacting is carried out until the mineral constituent has a d(50) particle size of 800 nm, preferably 400 nm, more preferably 300 nm, determined by means of static light scattering. This is, in particular, carried out using a milling apparatus.

It has been found to be advantageous for a rest time of the suspension of from 0.01 to 48 h, preferably 4 to 24 h, more preferably 6 to 16 h, to be observed before the introduction of kinetic energy, during which time the suspension rests or is stirred in order to prevent sedimentation in a stirred vessel without action of high shearing energy, i.e. shearing energies of <50 kWh per metric ton of suspension. When the contacting with the polymeric dispersant is carried out in two stages, the rest time can be implement before the first stage or between the two stages.

Before, during or after contacting of the mineral constituent with the dispersant, an acidic compound having a molecular weight of not more than 200 g/mol, preferably 40 to 100 g/mol, can be added. The addition of acidic compound is preferably carried out after contacting of the mineral constituent with the dispersant has occurred. The acidic compound is, for example, selected from nitric acid, sulfamic acid, methanesulfonic acid, formic acid, acetic acid, sulfuric acid and mixtures thereof, preferably sulfamic acid, methanesulfonic acid, acetic acid and mixtures thereof. The amount of the acidic compound is appropriately selected such that a pH of the suspension of 11.0 to 13.0, preferably 11.4 to 12.5, more preferably 11.8 to 12.4, is obtained immediately after the addition of acid (10 to 60 s) or after complete homogenization.

### Alkanolamine

The hardening accelerator composition of the invention comprises an alkanolamine selected from diethanolamine (DEA) and methyl diethanolamine (MDEA), or mixtures thereof. As shown by the examples and comparative examples that follow, the nature of the alkanolamine is critical, and not every alkanolamine will result in the desired effect. Hence, it appears crucial that the nitrogen atom bears two 2-hydroxyethyl groups and the further substituent causes no or only limited steric hindrance.

In addition to diethanolamine (DEA) and methyl diethanolamine (MDEA), it is also possible to use other alkanolamines such as triisopropanolamine (TIPA), monoethanolamine (MEA), triethanolamine (TEA), diethanolisopropanolamine (DEIPA). If a combination of DEA and/or MDEA with other alkanolamines is used, DEA and/or MDEA preferably account for at least 25 wt.-% of the total amount of alkanolamines.

### Cementitious Composition

The invention also relates to a cementitious composition, comprising a cementitious binder and the hardening accelerator composition of the invention.

The hardening accelerator compositions of the invention are preferably added in amounts of from 0.01 to 15 wt.-%, preferably from 0.1 to 10 wt.-%, more preferably from 0.1 to 5 wt.-%, of the solid of the compositions, based on the cementitious binder.

The cementitious binder may be selected from Portland cement, calcium sulfoaluminate cements and/or calcium aluminate cements, preferably Portland cement. The composition may comprise a latent hydraulic binder, in particular slag, preferably granulated blast furnace slag, flyash, silica flour, metakaolin, natural pozzolans, calcined oil shale.

The cementitious composition of the invention can also comprise further additives which are typically used in the field of building chemicals, for example other curing accelerators, dispersants, plasticizers, water reducers, setting retarders, anti-foaming agents, air pore formers, retarders, shrinkage-reducing agents, redispersible powders, freezing protection agents and/or anti-efflorescence agents.

Further suitable other curing accelerators are, for example, calcium chloride, calcium formate, calcium nitrate, inorganic carbonates such as sodium carbonate or potassium carbonate, 1,3-dioxolan-2-one and 4-methyl-1,3-dioxolan-2-one.

Preference is given to using calcium formate and calcium nitrate in an amount of from 0.1 to 4 wt.-%, based on the cementitious binder.

Suitable dispersants, plasticizers, water reducers are, for example those exemplified above.

Suitable setting retarders are citric acid, tartaric acid, gluconic acid, phosphonic acid, aminotrimethylenephosphonic acid, ethylenediaminotetra(methylenephosphonic) acid, diethylenetriaminopenta(methylenephosphonic) acid, in each case including the respective salts of the acids, pyrophosphates, pentaborates, metaborates and/or sugars such as glucose or molasses. The advantage of the addition of setting retarders is that the open time can be controlled and in particular may be able to be extended. The setting retarders are preferably used in an amount of from 0.01 to 0.5 wt.-%, based on the weight of the cementitious binder, preferably cement.

The present invention can be further explained and illustrated on the basis of the following figures and examples.

### EXAMPLES

### Methods

1. Particle size of the raw material (mineral constituent) The particle size of the raw material for wet milling was characterized by means of static light scattering. The Mastersizer 2000 instrument manufactured from Malvern was used for this purpose.
2. Determination of the specific surface area by the BET method
The specific BET surface area of the raw material for wet milling was determined by means of nitrogen adsorption. The “NOVA 4000e Surface Area and Pore Size Analyzer” instrument manufactured from Quantachrome was used for this purpose. For the measurements, the samples were dried beforehand to constant weight at 105° C.
3. X-ray diffraction analysis (XRD) and Rietveld analysis for determination of the proportion of X-ray-amorphous material in and the crystallite size of the calcium silicate hydrate

The XRDs were recorded using a Bruker AXS D4 ENDEAVOR (Cu Kα radiation, 40 kV, 40 mA) and the Rietveld measurements were carried out using the Topas 4.2 software from Bruker.

For the XRD analysis, the hydrothermal C—S—H was comminuted by means of a jaw crusher and opposed impingement mill to a particle size having a d(95) of 1 mm. Subsequently, 5 g of the powder were dried at 105° C. for 1 h in a laboratory oven. For the XRD analysis, 2 g of the dried powder was in each case comminuted in an agate mortar until the sample could be brushed in its entirety through a sieve having a mesh opening of 36 μm.

The sample for determining the proportion of the X-ray-amorphous phase was a homogeneously mixed powder which comprised the sample and a known amount of an internal crystalline standard. For these studies, from 15 to 30 wt.-% of fluorite (CaF₂) were triturated homogeneously with the sample (particle size<36 μm) in an agate mortar. The homogenized powder, which comprises fluorite as internal standard, was subsequently prepared and measured by means of “front loading”. A prerequisite for the use of fluorite as internal standard is that fluorite is not present in the original sample. It is necessary to select a standard having a mass attenuation coefficient (MAC) which is similar to that of the sample in order to minimize the X-ray adsorption contrast. The samples have an MAC for Cu Kα radiation in the range from 75 to 80 cm²/g. For this reason, CaF₂ having an MAC of 94.96 cm²/g was selected. The scientific literature recommends an amount of internal standard of about 20 wt.-% for an amorphous content in the range of from 30 to 90% in the sample to be measured (Scrivener, Snellings, and Lothenbach. “Chapter 4. X-Ray Powder Diffraction Applied to Cement.” A Practical Guide to Microstructural Analysis of Cementitious Materials. CRC/Taylor & Francis Group, 2016, 107-176). The examined samples comprise from 10 to 70 wt.-% of X-ray-amorphous or nanocrystalline phases having crystallite sizes of <5 nm, so that 15 wt.-% and 30 wt.-% of internal standard were used.

The X-ray diffraction patterns (diffractograms) recorded by means of X-ray diffraction analysis were subsequently evaluated by means of Rietveld analysis using the software Topas 4.0. The Rietveld method is a standard method for evaluating diffraction patterns obtained by X-ray diffraction analysis of powder samples. The method is comprehensively described in, for example, G. Will (2006): Powder Diffraction —The Rietveld method and the two-stage method, Springer Verlag; and R. Young (1995): The Rietveld method, IUCr Monographs on Crystallography, vol. 5, Oxford University Press.

The following structural data from the Inorganic Crystal Structure Database (ICSD) were used for the Rietveld analysis of the present samples:

Tobermorite (mineral of the calcium silicate hydrates): ICSD number 152489
Calcite: ICSD number 79674
Quartz: ICSD number 174
Portlandite: ICSD number 15471
Fluorite: ICSD number 60368 The phase content of the individual phases and also the crystallite size of the calcium silicate hydrate phase tobermorite were determined by means of Rietveld analysis.

The crystallite size is indicated by the width at half height of the reflections of a phase and is determined in the refinement during the Rietveld analysis. The relationship between width at half height of a reflection in the diffraction pattern and the crystallite size is described, for example, in chapter 5.4.1, page 142 onwards, in R. Dinnebier, S. Billinge (2008): Powder Diffraction —Theory and Practice, RSC Publishing; and on page 113 in G. Will (2006): Powder Diffraction —The Rietveld method and the two-stage method, Springer Verlag; and also R. Young (1995): The Rietveld method, IUCr Monographs on Crystallography, vol. 5, Oxford University Press.

The determination of the proportion of the X-ray-amorphous phase by means of an internal standard serves to quantify the absolute amount of the crystalline phases and the X-ray-amorphous phases and was carried out in accordance with the publication by I. Madsen, N. Scarlett and A. Kern, “Description and survey of methodologies for the determination of amorphous content via X-ray powder diffraction.” Zeitschrift fur Kristallographie Crystalline Materials 226.12 (2011): 944-955. Here, the known proportion of the internal standard is set down during the Rietveld refinement and the other phases are related thereto. The difference between the sum of the crystalline phases (tobermorite, calcite, quartz, portlandite, fluorite) and 100 wt.-% corresponds to the proportion of X-ray-amorphous material in the sample.

### Materials

C—S—H seed preparation “NHA 1000” comprising an amorphous C—S—H preparation was prepared according to example “Acc. 5” of table 2 of WO 2010/026155 A1.

C—S—H seed preparation “NHA 2240” comprising a semi-ordered calcium silicate hydrate having an apparent crystallite size of about 3.6 nm, prepared by hydrothermal reaction of quartz and caustic lime according to WO 2018/154013, comminuted and stabilized by a polycarboxylate ether.

### FIGURES AND EXAMPLES

FIG. 1 depicts weight ratios of different alkanolamines to NHA 2240 vs. compressive strength of mortar specimen after 6 h at 20° C.

FIG. 2 depicts weight ratios of different alkanolamines to NHA 2240 vs. compressive strength of mortar specimen after 8 h at 20° C.

### THE FOLLOWING ABBREVIATIONS ARE USED THROUGHOUT THE EXAMPLES

DEA: diethanolamine
MDEA: methyl diethanolamine
MEA: monoethanolamine
TEA: triethanolamine
DEIPA: diethanolisopropanolamine
TIPA: triisopropanolamine

Example 1: Compressive strength of concrete and mortar specimen using NHA 2240 and different amines

Concrete specimen (15×15×15 cm) and mortar specimen (4×4×16 cm) using CEM I 52.5 R as cement source, optionally together with NHA 2240 and different amines in different ratios, were prepared (EN 12390-3 and EN 196-1). The concrete specimen and the mortar specimen were investigated for their compressive strength after 6 h and 8 h. Differences in the absolute values of the concrete specimen and the mortar specimen are related to the different shapes and sizes of the specimen. The results are shown in table 1.

The concrete samples were prepared as follows:
all the aggregates were mixed with 50% of water for 1 minute
after 1 minute of pause, cement was added
cement was mixed for 1 minute with remaining water
dispersant was added and mixed for 1 minute

| | Content |
|---|---|
| | [kg/m³] |
| CEM I 52.5 R | 400 |
| Colacem Ghigiano | |
| Natural sand 0-0.5 mm | 240 |
| Natural sand 0-1 mm | 145 |
| Natural sand 0-2 mm | 240 |
| Natural sand 2-4 mm | 340 |
| Gravel 12-19 mm | 950 |
| MasterGlenium Ace | 0.5% bwoc |
| 440 | |
| Water | 160 |

The mortar samples were prepared as follows:
all the sands were mixed with 50% of water for 1 minute
after 1 minute of pause, cement was added
cement was mixed for 1 minute with remaining water
dispersant was added and mixed for 1 minute

| | Content [gr] |
|---|---|
| CEM I 52.5 R | 577 |
| Colacem Ghigiano | |
| Natural sand 0-0.5 mm | 355 |
| Natural sand 0-1 mm | 214 |
| Natural sand 0-2 mm | 355 |
| Natural sand 2-4 mm | 504 |
| MasterGlenium Ace | 0.85% bwoc |
| 440 | |
| Water | 220 |

TABLE 1

| | NHA | amine | concrete | | mortar | |
|---|---|---|---|---|---|---|
| | 2240 | type | CS ^{[1]} | CS ^{[1]} | CS ^{[1]} | CS ^{[1]} |
| | dosage | (dosage | 6 h | 8 h | 6 h | 8 h |
| # | [% bwoc] | [% bwoc]) | [MPa] | [MPa] | [MPa] | [MPa] |
| 1* | 0.48 | — (0) | 11.5 | 28.9 | 14.0 | 40.2 |
| 2* | 0.46 | TEA | 3.1 | 17.6 | n.d. ^{[2]} | n.d. ^{[2]} |
| | | (0.09) | | | | |
| 3* | 0.36 | TEA | 0.7 | 5.7 | n.d. ^{[2]} | n.d. ^{[2]} |
| | | (0.43) | | | | |
| 4* | 0.29 | TEA | 0.7 | 3.0 | n.d. ^{[2]} | n.d. ^{[2]} |
| | | (0.68) | | | | |
| 5* | 0.46 | TIPA | 8.4 | 26.9 | 15.1 | 45.5 |
| | | (0.09) | | | | |
| 6* | 0.36 | TIPA | 10.7 | 31.4 | 9.5 | 44.1 |
| | | (0.43) | | | | |
| 7* | 0.29 | TIPA | 4.3 | 21.1 | 3.2 | 25.6 |
| | | (0.68) | | | | |
| 8 | 0.46 | MDEA | 12.1 | 35.3 | 36.9 | 58.1 |
| | | (0.09) | | | | |
| 9 | 0.36 | MDEA | 11.6 | 29.3 | 37.5 | 50.8 |
| | | (0.43) | | | | |
| 10 | 0.29 | MDEA | 13.2 | 29.4 | 22.8 | 40.0 |
| | | (0.68) | | | | |

^{[1]} compressive strength at 20° C.
^{[2]} not determined
*comparative example

It is evident from the results of table 1 that the combination of INHA 2240 and MDEA (see entries 8 to 10) is favorable regarding compressive strength of the concrete specimen and the mortar specimen in comparison the combination of NHA 2240 and either of TEA and TIPA (see entries 2 to 7) or NHA 2240 without amine (entry 1).

### Example 2

For example 2, the following concrete mix was prepared:

| | Content |
|---|---|
| | [kg/m³] |
| CEM I 52.5 R | 400 |
| Colacem Ghigiano | |
| Natural sand 0-0.5 mm | 240 |
| Natural sand 0-1 mm | 145 |
| Natural sand 0-2 mm | 240 |
| Natural sand 2-4 mm | 340 |
| Gravel 12-19 mm | 950 |
| MasterGlenium Ace | 0.5% bwoc |
| 440 | |
| Water | 160 |

The above components except the dispersant were mixed together with 100% of the water for 2 min in a planetary concrete mixer. The dispersant was added to the mixture and mixing was continued for another 1 min.

In the context of example 2, concrete specimen (15×15×15 cm) were prepared from the above concrete mix which optionally contained additional NHA 2240 and/or MDEA, see table 2. The concrete specimens were investigated for their compressive strength after 8 h at 10° C. and 20° C. The results are shown in table 2.

TABLE 2

| | | | concrete | |
|---|---|---|---|---|
| | NHA 2240 | MDEA | CS ^{[1]} 8 h at | CS ^{[1]} 8 h at |
| | dosage [% | dosage [% | 10° C. | 20° C. |
| # | bwoc] | bwoc] | [MPa] | [MPa] |
| 11* | 0 | 0 | 0 | 9 |
| 12 | 0 | 0.17 | 1 | 10 |
| 13* | 0.46 | 0 | 6 | 29 |
| 14 | 0.41 | 0.17 | 8 | 35 |

^{[1]} compressive strength
*comparative example

It is evident from the results of table 2 that the combination of NHA 2240 and MDEA acts synergistically regarding compressive strength of the concrete specimen.

### Example 3

For example 3, the following mortar mix was prepared:

| | Content [g] |
|---|---|
| CEM II/A-LL 52.5 R | 898.5 |
| Saint Pierre la Cour Lafarge | |
| Sand Mosole | 2164.5 |
| MasterGlenium Ace 440 | 0.6% bwoc |
| Water | 305 |

Sand plus 60% of water were mixed in a planetary mixer for 60 seconds. After 1 minutes of pause, cement was added with the remaining water and the superplasticizer and mixed for 90 seconds.

In the context of example 3, mortar specimen (4×4×16 cm) were prepared from the above mortar mix which optionally contained additional NHA 1000 or NHA 2240 and MDEA and/or TIPA, see table 3. The mortar specimens were investigated for their compressive strength after 6 h and 8 h. The results are shown in table 3.

TABLE 3

| | | | | mortar | |
|---|---|---|---|---|---|
| | C-S-H type | MDEA | TIPA | CS ^{[1]} | CS ^{[1]} |
| | (dosage [% | dosage [% | dosage [% | 6 h | 8 h |
| # | bwoc]) | bwoc] | bwoc] | [MPa] | [MPa] |
| 15* | — (0) | 0 | 0 | 5.0 | 11.3 |
| 16* | NHA 1000 (0.48) | 0 | 0 | 8.8 | 15.6 |
| 17* | NHA 1000 (0.41) | 0.17 | 0 | 8.5 | 19.4 |
| 18* | NHA 1000 (0.41) | 0.13 | 0.04 | 7.8 | 21.9 |
| 19* | NHA 1000 (0.41) | 0.09 | 0.09 | 7.6 | 21.5 |
| 20* | NHA 1000 (0.41) | 0.04 | 0.13 | 7.6 | 22.0 |
| 21* | NHA 1000 (0.41) | 0 | 0.17 | 6.2 | 14.2 |
| 22* | NHA 2240 (0.48) | 0 | 0 | 8.1 | 14.6 |
| 23 | NHA 2240 (0.41) | 0.17 | 0 | 9.6 | 25.0 |
| 24 | NHA 2240 (0.41) | 0.13 | 0.04 | 8.6 | 21.8 |
| 25 | NHA 2240 (0.41) | 0.09 | 0.09 | 7.4 | 19.6 |
| 26 | NHA 2240 (0.41) | 0.04 | 0.13 | 7.1 | 16.1 |
| 27* | NHA 2240 (0.41) | 0 | 0.17 | 5.3 | 13.0 |

^{[1]} compressive strength at 20° C.
*comparative example

It is evident from the results of table 3 that compressive strength was improved in mortar specimen containing MDEA for both NHA 1000 and NHA 2240 (see entries 17 and 23). The effect was more pronounced for NHA 2240 (see entry 23) in comparison to NHA 1000 (see entry 17). Entries 24 to 26 show that MDEA may be partially replaced by another alkanolamine such as TIPA. However, TIPA as the only alkanolamine results in insufficient compressive strength development.

### Example 4

For example 4, the following mortar mix was prepared:

| | Content [g] |
|---|---|
| CEM I 52.5 R | 599 |
| Colacem Ghigiano | |
| Sand Mosole | 1443 |
| MasterGlenium Ace 440 | 0.85% bwoc |
| Water | 220 |

Sand plus 60% of water were mixed in a planetary mixer for 60 seconds. After 1 minutes of pause, cement was added with the remaining water and the superplasticizer and mixed for 90 seconds.

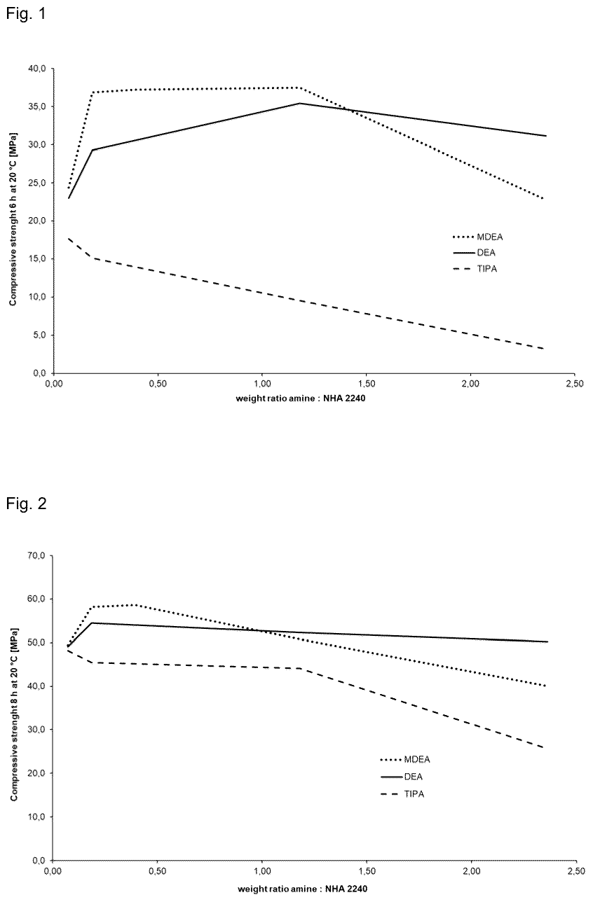

In the context of example 4, mortar specimens (4×4×16 cm) were prepared from the above mortar mix together with NHA 2240 and optionally an amine, see table 4. The mortar specimens were investigated for their compressive strength after 6 h and 8 h. The results are shown in table 4 and FIG. 1 and FIG. 2.

TABLE 4

| | NHA | | weight | | |
|---|---|---|---|---|---|
| | 2240 | | ratio | mortar | |
| | dosage | amine type | amine: | CS ^{[1]} | CS ^{[1]} |
| | [% | dosage [% | NHA | 6 h | 8 h |
| # | bwoc] | bwoc] | 2240 | [MPa] | [MPa] |
| 28* | 0.48 | — (0) | 0 | 14.0 | 40.2 |
| 29* | 0.47 | TIPA (0.03) | 0.07 | 17.6 | 48.2 |
| 30* | 0.46 | TIPA (0.09) | 0.19 | 15.1 | 45.5 |
| 31* | 0.36 | TIPA (0.43) | 1.18 | 9.5 | 44.1 |
| 32* | 0.29 | TIPA (0.68) | 2.36 | 3.2 | 25.6 |
| 33 | 0.47 | MDEA (0.03) | 0.07 | 24.4 | 49.4 |
| 34 | 0.46 | MDEA (0.09) | 0.19 | 36.9 | 58.1 |
| 35 | 0.43 | MDEA (0.17) | 0.39 | 37.2 | 58.6 |
| 36 | 0.36 | MDEA (0.43) | 1.18 | 37.5 | 50.8 |
| 37 | 0.29 | MDEA (0.68) | 2.36 | 22.8 | 40.0 |
| 38 | 0.47 | DEA (0.03) | 0.07 | 23.0 | 49.1 |
| 39 | 0.46 | DEA (0.09) | 0.19 | 29.3 | 54.5 |
| 40 | 0.36 | DEA (0.43) | 1.18 | 35.4 | 52.4 |
| 41 | 0.29 | DEA (0.68) | 2.36 | 31.2 | 50.3 |
| 42* | 0.47 | MEA (0.03) | 0.07 | 13.7 | 40.9 |
| 43* | 0.46 | MEA (0.09) | 0.19 | 13.1 | 36.8 |
| 44* | 0.36 | MEA (0.43) | 1.18 | 11.7 | 33.7 |
| 45* | 0.29 | MEA (0.68) | 2.36 | 7.8 | 32.2 |

^{[1]} compressive strength at 20° C.
*comparative example

It is evident from the results of table 5 that compressive strength was improved in mortar specimen containing IDEA or MDEA (see entries 33 to 41) in comparison to mortar specimen containing TIPA (see entries 29 to 32) or MEA (see entries 42 to 45).

### Example 5

For example 5, the following mortar mix was prepared:

| | Content g |
|---|---|
| CEM II/A-LL 52.5 R | 899 |
| Saint Pierre la Cour Lafarge | |
| Sand Mosole | 2165 |
| MasterGlenium Ace 440 | 0.6% bwoc |
| Water | 305 |

Sand plus 60% of water were mixed in a planetary mixer for 60 seconds. After 1 minutes of pause, cement was added with the remaining water and the superplasticizer and mixed for 90 seconds.

In the context of example 5, mortar specimens (4×4×16 cm) were prepared from the above mortar mix together with NHA 1000 or NHA 2240 which optionally contained an additional amine, see table 5. The mortar specimens were investigated for their compressive strength after 8 h. The results are shown in table 5.

TABLE 5

| | | amine type | mortar |
|---|---|---|---|
| | C-S-H type | (dosage [% | CS ^{[1]} 8 h |
| # | (dosage [% bwoc]) | bwoc]) | [MPa] |
| 46* | NHA 1000 (0.46) | — (0) | 15.6 |
| 47* | NHA 1000 (0.41) | TIPA (0.17) | 14.2 |
| 48* | NHA 1000 (0.41) | MDEA (0.17) | 19.4 |
| 49* | NHA 1000 (0.41) | DEA (0.17) | 15.6 |
| 50* | NHA 1000 (0.41) | MEA (0.17) | 11.3 |
| 51* | NHA 2240 (0.46) | — (0) | 14.6 |
| 52* | NHA 2240 (0.41) | TIPA (0.17) | 13.0 |
| 53 | NHA 2240 (0.41) | MDEA (0.17) | 25.0 |
| 54 | NHA 2240 (0.41) | DEA (0.17) | 14.9 |
| 55* | NHA 2240 (0.41) | MEA (0.17) | 10.0 |

^{[1]} compressive strength at 20° C.
*comparative example

It is evident from the results of table 5 that compressive strength was improved in mortar specimen containing DEA or MDEA for both NHA 1000 and NHA 2240 (see entries 48, 49, 53 and 54) in comparison to mortar specimen containing TIPA or MEA (see entries 47, 50, 52 and 55).

### Example 6

For example 6, the following concrete mix was prepared:

| | Content [kg/m³] |
|---|---|
| CEM I 52.5 R CPV-El Alto | 390 |
| Limestone filler | 90 |
| Sand 0/2 crushed | 275 |
| Sand 0/4 natural | 665 |
| Aggregate 4-12 mm | 780 |
| MasterEase 5025 | 1.1% bwoc |
| Accelerator | 1.5% bwoc |
| Water | 185 190 |

The concrete mix of example 6 was prepared as follows:
addition of aggregates with 50-60% of water for 1 minute
addition of cement with remaining water—1 min mix
addition of dispersant and mixed for 1 minute
addition of accelerator
mixing time until stable consistency (max. 4 min)

Concrete specimens (15×15×15 cm) were prepared from the above concrete mix. The accelerator is identified in table 6. The ratio of NHA 1000 or NHA 2240 to alkanolamine was 0.39. The concrete specimens were investigated for their compressive strength after 8 h and 17 h at 22° C. and after 17 h and 24 h at 8° C. (see table 6).

TABLE 6

| | | | concrete | | | |
|---|---|---|---|---|---|---|
| | | | CS ^{[1]} | CS ^{[1]} | CS ^{[2]} | CS ^{[2]} |
| | C—S—H | amine | 8 h | 17 h | 17 h | 24 h |
| # | type | type | [MPa] | [MPa] | [MPa] | [MPa] |
| 56* | — | — | 1.6 | 25.0 | 4.5 | 7.3 |
| 57* | NHA 1000 | — | 3.2 | 30.0 | 8.7 | 13.8 |
| 58 | NHA 1000 | MDEA | 8.5 | 33.0 | 11.5 | 21.3 |
| 59* | NHA 1000 | TIPA | 6.2 | 32.1 | 7.6 | 18.4 |
| 60* | NHA 1000 | DEIPA | 6.4 | 31.8 | 9.3 | 17.6 |
| 61* | NHA 1000 | TEA | 7.7 | 24.5 | 5.3 | 16.8 |
| 62* | NHA 2240 | — | 4.1 | 30.3 | 9.8 | 15.8 |
| 63 | NHA 2240 | MDEA | 12.7 | 33.4 | 12.4 | 25.5 |
| 64* | NHA 2240 | TIPA | 12.2 | 35.2 | 10.3 | 21.6 |
| 65* | NHA 2240 | DEIPA | 10.0 | 33.9 | 13.2 | 22.4 |
| 66* | NHA 2240 | TEA | 7.8 | 29.3 | 7.8 | 17.8 |

^{[1]} compressive strength at 22° C.
^{[2]} compressive strength at 8° C.
*comparative example

It is evident from the results of table 6 that compressive strength was improved in concrete specimen containing MDEA for both NHA 1000 and NHA 2240 (see entries 58 and 63) in comparison to concrete specimen containing TIPA, DEIPA or TEA (see entries 59 to 61 and 64 to 66).

### Example 7

For example 7, the following concrete mix was prepared:

| | Content [kg/m³] |
|---|---|
| CEM \| 52.5 R | 390 |
| Lafarge-Villaluenga | |
| Limestone filler | 90 |
| Sand 0/2 crushed | 275 |
| Sand 0/4 natural | 665 |
| Aggregate 4-12 mm | 780 |
| (MasterEase 5025) | 1.0% bwoc |
| Accelerator | 1.5% bwoc |
| Water | 185 190 |

The concrete mix of example 7 was prepared as follows:
addition of aggregates with 50-60% of water for 1 minute
addition of cement with remaining water—1 min mix
addition of dispersant and mixed for 1 minute
addition of accelerator
mixing time until stable consistency (max. 4 min)

Concrete specimen (15×15×15 cm) were prepared from the above concrete mix. The accelerator is identified in table 7. The ratio of NHA 1000 or NHA 2240 to alkanolamine was 0.39. The concrete specimen were investigated for their compressive strength after 8 h, 17 h and 24 h at 22° C. and after 17 h and 24 h at 8° C. (see table 7).

TABLE 7

| | | | concrete | | | | |
|---|---|---|---|---|---|---|---|
| | | | CS ^{[1]} 8 h | CS ^{[1]} 17 h | CS ^{[1]} 24 h | CS ^{[2]} 17 h | CS ^{[2]} 24 h |
| # | C—S—H type | amine type | [MPa] | [MPa] | [MPa] | [MPa] | [MPa] |
| 67* | — | — | 1.1 | 13.3 | 28.3 | 1.0 | 2.9 |
| 68* | NHA 1000 | — | 1.6 | 17.2 | 26.6 | 1.4 | 3.8 |
| 69 | NHA 1000 | MDEA | 1.6 | 23.7 | 33.0 | 1.5 | 5.2 |
| 70* | NHA 1000 | TIPA | 1.2 | 17.2 | 33.4 | 1.1 | 3.7 |
| 71* | NHA 1000 | DEIPA | 0.9 | 19.1 | 31.8 | 0.6 | 3.2 |
| 72* | NHA 1000 | TEA | 1.1 | 16.7 | 29.5 | 0.7 | 3.6 |
| 73* | NHA 2240 | — | 2.1 | 17.3 | 28.8 | 1.5 | 4.3 |
| 74 | NHA 2240 | MDEA | 2.0 | 27.7 | 35.9 | 2.4 | 6.7 |
| 75* | NHA 2240 | TIPA | 1.3 | 26.6 | 35.8 | 1.5 | 4.8 |
| 76* | NHA 2240 | DEIPA | 0.9 | 19.7 | 33.3 | 0.8 | 3.3 |
| 77* | NHA 2240 | TEA | 1.1 | 15.6 | 29.8 | 0.6 | 3.5 |

^{[1]} compressive strength at 22° C.
^{[2]} compressive strength at 8° C.
*comparative example

It is evident from the results of table 7 that compressive strength was improved in concrete specimen containing MDEA for both NHA 1000 and NHA 2240 (see entries 69 and 74) in comparison to concrete specimen containing TIPA, DEIPA or TEA (see entries 70 to 72 and 75 to 77).

1. A hardening accelerator composition for cementitious compositions, comprising
(a) a C—S—H seed component comprising a finely dispersed mineral constituent stabilized by a polymeric water-soluble dispersant, the mineral constituent comprising a semi-ordered calcium silicate hydrate having an apparent crystallite size of 15 nm or less, and
(b) an alkanolamine selected from diethanolamine (DEA) and methyl diethanolamine (MDEA), or mixtures thereof.

2. The hardening accelerator composition of claim 1, comprising a synergistically active ratio of the C—S—H seed component (a) and the alkanolamine (b).

3. The hardening accelerator composition of claim 1, wherein the weight ratio of the alkanolamine (b) to the C—S—H seed component (a) is in the range of from 0.07 to 2.4, calculated on a solids basis.

4. The hardening accelerator composition of claim 1, wherein the mineral constituent comprises a molar ratio of calcium to silicon in the range of from 0.5 to 2.5.

5. The hardening accelerator composition of claim 1, wherein the polymeric water-soluble dispersant is a polymer having a carbon-containing backbone to which pendant cement-anchoring groups and polyether side chains are attached.

6. The hardening accelerator composition of claim 1, wherein in the C—S—H seed component (a), the weight ratio of the mineral constituent to the polymeric water-soluble dispersant is in the range of from 1:1 to 5:1, calculated on a solids basis.

7. A cementitious composition, comprising a cementitious binder and the hardening accelerator composition of claim 1.

8. The cementitious composition of claim 7, comprising 0.29 to 0.51% of the C—S—H seed component (a), and 0.03 to 0.70% of the alkanolamine (b), calculated on a solids basis by weight of the cementitious binder.

9. The cementitious composition of claim 7, wherein the cementitious binder is Portland cement.

10. The cementitious composition of claim 7, further comprising an aggregate, selected from sand and coarse aggregate.

11. The cementitious composition of claim 7, further comprising an additional amount of a dispersant.

12. The cementitious composition of claim 7, comprising 10 to 25%, of the cementitious binder, calculated on a solids basis by weight of the total amount of the cementitious composition.

13. The cementitious composition of claim 7, exhibiting a 6-hour compressive strength according to DIN EN 196-1 of at least 10 MPa.

14. A process for accelerating the hardening of a cementitious composition comprising a cementitious binder, the process comprising adding the hardening accelerator composition of claim 1 to the cementitious composition.

15. The hardening accelerator composition of claim 3, wherein the weight ratio of the alkanolamine (b) to the C—S—H seed component (a) is in the range of from 0.19 to 0.5, calculated on a solids basis.

16. The hardening accelerator composition of claim 4, wherein the mineral constituent comprises a molar ratio of calcium to silicon in the range of from 1.0 and 1.8.

17. The hardening accelerator composition of claim 6, wherein in the C—S—H seed component (a), the weight ratio of the mineral constituent to the polymeric water-soluble dispersant is in the range of from 2:1 to 3:1, calculated on a solids basis.

18. The cementitious composition of claim 9, wherein the cementitious binder is Ordinary Portland Cement (OPC).

19. The cementitious composition of claim 12, comprising 12 to 20% of the cementitious binder, calculated on a solids basis by weight of the total amount of the cementitious composition.
